(19) United States
(12) Patent Application Publication
(10) Pub. No.: US 2007/0268451 A1
(43) Pub. Date: Nov. 22, 2007

(54) Quadrifocal Lens

(76) Inventor: Puthalath K. Raghuprasad, Odessa, TX (US)

Correspondence Address: DAVID L. KING, SR., 5131 N.E. COUNTY ROAD 340, HIGH SPRINGS, FL, 32643, US

(21) Appl. No.: 11/419,291

(22) Filed: May 19, 2006

(51) Int. Cl. G02C 7/06

(52) U.S. Cl. 351/168

(57) ABSTRACT

A multifocal lens 20, 20A, having an upper distance vision power zone 23; a lower near vision power zone 24; an intermediate power zone 25 between the upper distance vision power zone 23 and the lower near vision power zone 24; and an upper near vision power zone 26 above a portion of the upper distance vision power zone 23 are disclosed. The lower near vision power zone 24 extends from the nose side outwardly. The upper near vision power zone 26 extends from the nose side outwardly. Preferably the lower near vision zone 24 extends outwardly and downwardly from the nose side adjacent the intermediate vision zone 25 in a curved path and extends less than 70% across the length of the lens. Similarly the upper near vision zone 26 extends outwardly and upwardly from the nose side adjacent the upper distance vision power zone 23 in a curvilinear path and extends a suitable distance across the entire length of the lens or a part thereof.

### TECHNICAL FIELD

This invention relates to eyeglasses generally, more specifically multifocal lenses.

### BACKGROUND OF THE INVENTION

The use of bifocal lenses or multifocal lenses such as progressive addition lenses for the treatment of presbyopia is well known. Typically the lenses are divided into three zones of distance (far vision), intermediate and near vision power. As shown in FIG. 1 distance or far vision zone of a typical pair of glasses is in an upper portion of the lens, a reading area or near vision area is located at a lower portion of the lens, and an intermediate area or progressive area is positioned between the distance area and the reading area.

In U.S. Pat. No. 6,074,061 entitled “Progressive Focal Lens for Eyeglasses” it was reported that the typical glasses as described above creates a near vision blurring in the intermediate or progressive region in the area near the nose. To remedy this condition the inventor proposed a progressive lens wherein the near vision or reading area occupies the area near the nose that normally was reserved for the intermediate area.

In U.S. Pat. No. 6,886,938 the inventor, Menezes, discloses that the near vision or reading zone of such lenses as found in FIG. 1 creates a problem for focusing when one looks at the ground or climbs a stair creating a blurred vision requiring the wearer to either remove the glasses or to stoop to see. Menezes proposed a lens containing four zones consisting of a.) a distance vision power zone; b.) a near vision power zone comprising an add power; c.) an intermediate vision power zone between the distance and near vision power zones; and d.) a fourth zone located inferior to the near vision power zone, wherein the fourth zone has a constant power that is within about 20 to about 80% of the add power. By “add power” is meant the amount of dioptic power difference between the near and far vision zones of the lens along the central or 90-270 degree meridian of the lens. This lens it was hoped would reduce the blur when looking down through the lower region of the lens at a distance of more than 45 cm from the eye.

A quite large array of vision problems are presented to the wearer of such multifocal lenses.

A more recent and persistent problem that heretofore has not been addressed is the need to near vision read at eye levels that are straight or even upwardly directed. These requirements have come into play with the wide use of computer screens and television monitors displaying written text messages and reading x-rays by radiologist. Such devices are often at or above normal eye level and as such a wearer of normal multifocal lenses must contort their neck in an exaggerated backward tilt to read through the low positioned near vision area or zone. A similar problem exists for airplane pilots whose gauges are spread at, above or below eye level throughout the cockpit. Alternatively the wearer of such glasses can try to move away from the instrument panel or the computer monitor and read through the intermediate zone, however, such an option is not practical for the user who must operate a control panel or a keyboard closely situated relative to the displayed text.

The present invention as described below provides a unique lens configuration that addresses this problem.

### SUMMARY OF THE INVENTION

A multifocal lens, having an upper distance vision power zone; a lower near vision power zone; an intermediate power zone between the upper distance vision power zone and the lower near vision power zone; and an upper near vision power zone above at least a portion of the upper distance vision power zone are disclosed. The lower near vision power zone extends from the nose side outwardly. The upper near vision power zone also extends from the nose side outwardly. Preferably the lower near vision zone extends outwardly and downwardly from the nose side adjacent the intermediate vision zone in a curved path and extends less than 70% across the length of the lens. Similarly the upper near vision zone extends outwardly and upwardly from the nose side adjacent the upper distance vision power zone in a curvilinear path and extends across the entire length of the lens or a part thereof.

The upper distance vision power zone extends form the nose side widening upwardly to a maximum width near an ear side of the lens and the intermediate power zone extends from near the nose side widening downwardly to a maximum width near the ear side of the lens. The upper distance vision power zone and the adjacent intermediate zone extend along a boundary from a near nose side to a near ear side along a generally linear or curvilinear path. Preferably the linear path is located at less than 50% the height of the lens; more preferably the linear path is located at less than 40% the height of the lens. The curvilinear path has a variable height wherein a majority of the path is located at less than 50% the height of the lens, more preferably less than 40% height of the lens. Ideally one or more of the adjacent zones progressively blend. The multifocal lens may have the zones located on one surface of the lens; preferably on the front side of the lens. Alternatively, the multifocal lens may have a back surface comprising one or more of a second upper distance vision power zone, a second intermediate vision power zone, a second lower near vision power zone or a second upper near vision power zone.

### BRIEF DESCRIPTION OF THE DRAWINGS

FIG. 1 is a schematic view of a typical progressive focal lens.

FIG. 2 is a front view of a pair of eyeglasses with the lens according to the present invention.

FIG. 3 is an enlarged view of an exemplary lens from FIG. 2.

FIG. 4 is an alternative embodiment wherein the upper near vision area and lower near vision area merge.

FIG. 5 is an alternative embodiment lens showing a second vision power zone on a back surface of a lens.

### DETAILED DESCRIPTION OF THE INVENTION

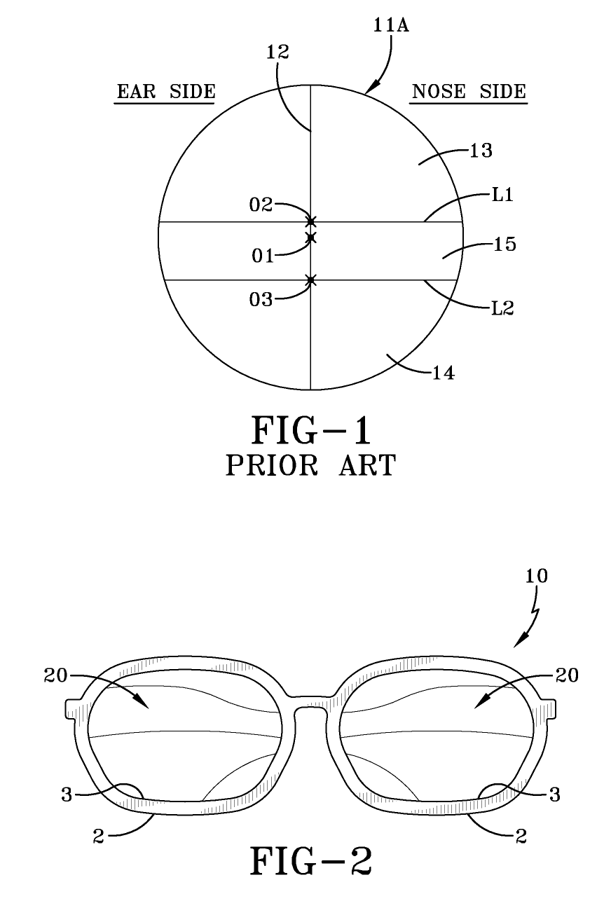

As shown in FIG. 1 and described in U.S. Pat. No. 6,074,061 a typical prior art progressive focal lens 11A has a distance area 13 located at an upper portion of the lens, a reading area 14 located at a lower portion of the lens, and an intermediate area or progressive area 15 positioned between the distance area 13 and the reading area 14. More specifically, the lens 11A has a principal meridional line 12 and a geometric center 01. A distance point 02 is provided on the principal meridional line 12 above the geometric center 01, and a reading point 03 is provided on the principal meridional line 12 below the geometric center 01. The distance area 13 is defined above a first horizontal line L1 that passes through the distance point 02. The distance area 13 has a spherical shape or a near spherical shape. The reading area 14 is defined below a second horizontal line L2 that passes through the reading point 03. The intermediate area 15 is defined between the lines L1 and L2.

The intermediate area 15 has an aspherical shape and a curvature that gradually changes from the curvature for the distance vision to the curvature for the near vision. The aspherical shape produces distortion. The distortion causes a person wearing the eyeglasses to encounter horizontal distortion when the line of sight is shifted vertically or results in a change in the size ratio of an object viewed when the line of sight is shifted horizontally. When the line of sight passes the intermediate area 15, therefore, reeling occurs, causing the wearer to feel uncomfortable. Because astigmatism associated with distortion is present in the intermediate area 15, an object being viewed may be blurred.

The proposed solution in U.S. Pat. No. 6,074,061 which is being incorporated herein by reference in its entirety was suggested that the principal meridian line 12 should be shifted near the nose side area in the progressive area and the reading area. This takes advantage of convergence by which the right and left eyes come close to each other at the time of viewing a near object.

The present inventive glasses of FIG. 2 illustrates a new and totally unappreciated lens improvement in near vision reading without diminishing the distance vision aspects required for normal far vision requirements as driving or flying an aircraft.

As shown in FIG. 2 a pair of glasses 10 has a frame 2 holding a pair of lenses 20 for both hyperopic and myopic use fitted in rings 3 of the frame 2.

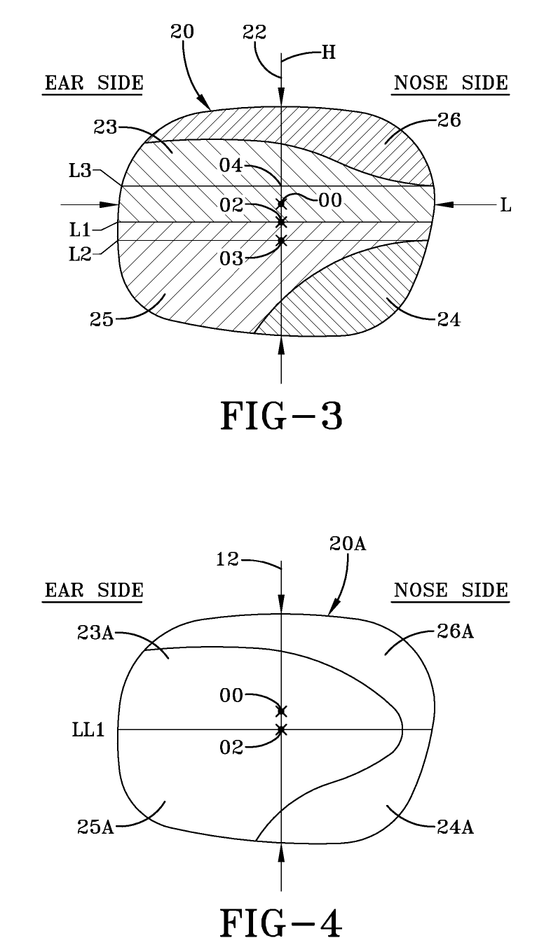

The lens 20 as shown in greater detail in FIG. 3 is made according to a first embodiment of the invention and has a principal meridian line 22 whose lower part in an intermediate area or zone 25 and a lower near vision or lower reading area or zone 24 may be shifted by a predetermined distance toward the nose side area, as was taught in U.S. Pat. No. 6,074,061 or can cross the principal meridional line 22 to extend a distance of 70% or less from the nose side toward the ear side as shown.

A geometric center 00 of the lens 20 dividing the lens in half is shown on the principal meridional line 22 and a distance point 02 is provided preferably at or below the geometric center 00 or about 40% of the lens height H. An upper distance vision power zone or area 23 is defined above a first horizontal line L1 that passes through the point 02. A lower near vision or reading point 03 is provided below the geometric center 00 preferably at or below the distance point 02. The lower near vision or reading area or zone 24 is defined below a second horizontal line L2 that passes through the lower near vision point 03. The intermediate area or zone 25 is defined below the line L1 and above a portion of line L2 extending from near the nose side of the lens to the ear side of the lens and curves below the line L2 crossing the principal meridional line 22 and occupying the entire lower portion of the ear side of the lens, therefore the intermediate area or zone 25 occupies almost the entire area below line L1 excluding the area of the lower near vision area or zone 24. The curvature of the intermediate area or zone 25 gradually changes from the curvature of the upper distance area or zone 23 to near vision area or zone 24 as the intermediate area or zone extends from the upper distance area or zone toward the near vision area or zone. As shown, the vast majority of the lower near vision area or zone 24 lies on the nose side of the lens 20 between the principal meridional line 22 and the nose. The lower near vision zone 24 extends less than 70% across the lens length L from the nose side to the ear side.

The lens 20 in a region above the upper distance area or zone 23 has an upper near vision or reading area or zone 26. This upper near vision area or zone 26 is defined as being above a horizontal line L3 which intersects a point 04 on a principal meridional line 22 as shown. As shown, the upper near vision area or zone 23 curves from the line 04 and extends toward and intersects the principal meridional line 22 near the upper extreme of the lens extending a suitable distance extending across the entire lens length or a part thereof so the wearer can avoid shifting of his head while reading text or images from left to right when looking up. When one looks upwardly as compared to looking down there is less convergence of vision towards the nose side, accordingly the upper near vision area or zone 26 by extending across a majority of the length of lens 20 or 20A even up to the entire lens length provides a beneficial comfortable near vision reading zone in this region of the lens without appreciably reducing the upper distance vision area or zone 23. The upper distance vision area 23 occupies a large enough area such that the eyes focus on distance viewing is naturally directed in the area 23. In this way the vast majority of this upper near vision area or zone 26 can be closer to the nose region while extending a considerable distance across the lens as shown. Preferably the upper distance area or zone 23 approaches the upper near vision area or zone 26.

By way of example the lens 20, as shown in FIG. 3, has the upper distance vision power zone 23 occuping an area of less than 60% of the total lens area, as shown about 34%. The upper near vision power zone 26 occupies an area of less than 30%, as show about 17%. The intermediate vision power zone 25 occupies an area of less than 40% of the total lens area, as shown about 34%. The lower near vision power zone 24 occupies less than 20% of the total lens area, as shown about 15%. It is understood various alternative proportions may be used for any particular application and therefore these exemplary proportions are not intended to be limiting the scope of the invention in any way.

As described above for the right side lens the opposite lens on the left hand side has a similar upper near vision area or zone 26 and lower near vision area or zone 24 as well as a distance region and intermediate region.

While both the upper near vision and lower near vision areas or zone are shown as distinct spaced apart areas near the nose side it must be appreciated that the upper and lower near vision regions can optionally merge at or near the geometric centerline if desired as shown in lens 20A in FIG. 4. In this embodiment near the merging of the near vision areas the horizontal distance from the nose will be at a minimum.

The lenses of the invention may be designed using any known method including, without limitation, commercially available design software such as CODE V.TM., ZEMAX.TM. and the like. The additional zone may be designed integrally with the other zones of the surface or separately. If designed separately, the zone must be offset, tilted, and blended relation to the other ones so as to ensure power blending and minimization of unwanted astigmatism.

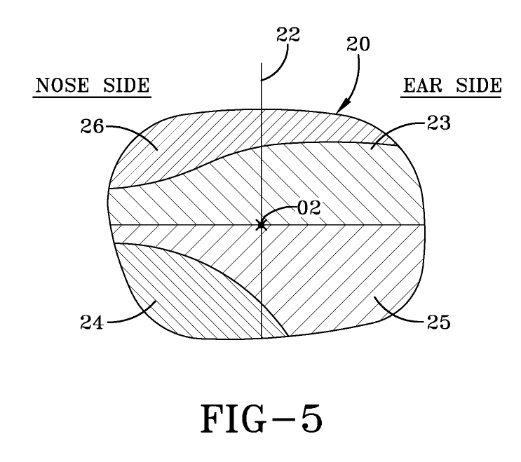

The lenses of the invention may be designed and manufactured using any suitable methods. A preferred method of designing the lenses of the invention is disclosed in U.S. Pat. No. 6,302,540 incorporated in its entirety herein by reference. The zones of the lens may be present on one surface or split between the front, or object side, and back, or eye side, surface of the lens. For example, each of the front and back surfaces may have four zones and each such zone may provide a portion of the power desired for that zone. In such an embodiment, preferably the front and the back surfaces are misaligned. By “misaligned” is meant that the surfaces, and thus the areas of unwanted astigmatism, are arranged or disposed in relation to one another so that a portion or all of the areas of maximum, localized, unwanted astigmatism, or the highest measurable level of unwanted astigmatism, contributed by one surface do not substantially coincide with one or more maximum, localized, unwanted astigmatism areas of the other surface. As shown in FIG. 5 a complete second set of zones is shown on the back side of the lens 30.

Alternatively, the front or back surface of the lens may provide the far distance, intermediate and lower near vision zones and the other lens surface may provide the fourth upper near vision zone. In one embodiment, the fourth zone is provided on the back surface of the lens and the near vision zone is provided on the front surface. In yet another embodiment, the lens of the invention may provide cylinder correction on one or both surfaces.

The lenses of the invention may be fabricated by any convenient means and constructed of any known material suitable for production of ophthalmic lenses. Suitable materials include, without limitation, mineral glass, polycarbonate, allyl diglycol, polyacrylates, polyurethanes and the like. Such materials are either commercially available or methods for their production are known. Further, the lenses may be produced by any conventional lens fabrication technique including, without limitation machining, grinding, whole lens casting, molding, thermoforming, laminating, surface casting, or combinations thereof. Casting may be carried out by any means, but preferably is performed by surface casting including, without limitation, as disclosed in U.S. Pat. Nos. 5,147,585, 5,178,800, 5,219,497, 5,316,702, 5,358,672, 5,480,600, 5,512,371, 5,531,940, 5,702,819, and 5,793,465 incorporated herein in their entireties by reference. Preferably, lens manufacturing is carried out by machining both surfaces of a polymeric or mineral glass article that has planar or curved surfaces. Regardless of the manufacturing process used, the lens may include a suitable coating including, without limitation, a scratch resistant coating, an anti-reflective coating, a photochromic coating, or the like.

We claim

1. A multifocal lens, comprising:
a.) an upper distance vision power zone;
b.) a lower near vision power zone;
c.) an intermediate power zone between the distance vision power zone and the lower near vision power zone;
d.) an upper near vision power zone above at least a portion of the upper distance vision power zone; and wherein the lower vision power zone extends from the nose side outwardly less than the entire length of the lens and wherein the intermediate power zone extends from near the nose side widening downwardly to a maximum width near the ear side of the lens.

2. (canceled)

3. The multifocal lens of claim 1 wherein the upper near vision power zone extends from the nose side outwardly.

4. The multifocal lens of claim 1 wherein the lower near vision zone extends outwardly and downwardly from the nose side adjacent the intermediate vision zone in a curved path.

5. (canceled)

6. The multifocal lens of claim 3 wherein the upper near vision zone extends outwardly and upwardly from the nose side adjacent the upper distance vision power zone in a curvilinear path.

7. The multifocal lens of claim 6 wherein the upper near vision zone extends less than the entire length of the lens.

8. The multifocal lens of claim 1 wherein the upper distance vision power zone extends from the nose side widening upwardly to a maximum width near an ear side of the lens.

9. (canceled)

10. The multifocal lens of claim 1 wherein the upper distance vision power zone and the adjacent intermediate zone extend along a boundary from a near nose side to a near ear side along a linear or curvilinear path.

11. The multifocal lens of claim 10 wherein the linear path is located at less than 50% the height of the lens.

12. The multifocal lens of claim 10 wherein the linear path is located at less than 40% the height of the lens.

13. The multifocal lens of claim 10 wherein the boundary between the upper distance vision power zone and the adjacent intermediate zone is a curvilinear path having a majority of the path located at less than 50% the height of the lens.

14. The multifocal lens of claim 1 wherein one or more of the adjacent zones progressively blend.

15. The multifocal lens of claim 1 wherein the zones are located on one surface of the lens.

16. The multifocal lens of claim 15 wherein the zones are located on the front side of the lens.

17. The multifocal lens of claim 16 further comprises a back surface comprising one or more of a second upper distance vision power zone, a second lower vision power zone, a second intermediate power zone and a second upper near vision power zone.

18. A multifocal lens, comprising:
a.) an upper distance vision power zone;
b.) a lower near vision power zone;
c.) an intermediate power zone between the distance vision power zone and the lower near vision power zone;
d.) an upper near vision power zone above at least a portion of the upper distance vision power zone; and
e.) wherein the upper near vision power zone extends from the nose side outwardly less than the entire length of the lens and wherein the upper distance vision power zone extends from the nose side widening upwardly to a maximum width near an ear side of the lens.

19. A multifocal lens, comprising:
a.) an upper distance vision power zone;
b.) a lower near vision power zone;
c.) an intermediate power zone between the distance vision power zone and the lower near vision power zone;
d.) an upper near vision power zone above at least a portion of the upper distance vision power zone; and
e.) wherein the lower near vision power zone extends from the nose side outwardly less than the entire length of the lens and the upper near vision power zone extends from the nose side outwardly less than the entire length of the lens and wherein the upper distance vision power zone extends from the nose side widening upwardly to a maximum width near an ear side of the lens and the intermediate power zone extends from near the nose side widening downwardly to a maximum width near the ear side of the lens.
